(19) United States
(12) Patent Application Publication
(10) Pub. No.: US 2022/0178375 A1
(43) Pub. Date: Jun. 9, 2022

(54) ELECTRIC WATER PUMP

(71) Applicant: YoungShin Precision Co., Ltd, Gyeongju-si Gyeongsangbuk-do (KR)

(72) Inventors: Do Jae JOO, Pohang-si (KR); Hong Ki KIM, Pohang-si (KR); Seong Wook CHA, Gyeongju-si (KR); Jae Gyeong LEE, Pohang-si (KR)

(73) Assignee: YoungShin Precision Co., Ltd, Gyeongju-si Gyeongsangbuk-do (KR)

(21) Appl. No.: 17/541,550

(22) Filed: Dec. 3, 2021

(30) Foreign Application Priority Data
Dec. 4, 2020 (KR) 10-2020-0168294

(51) Int. Cl. F04D 13/06; F04D 29/043; F04D 29/22; F04D 29/42

(52) U.S. Cl. CPC F04D 13/06; F04D 29/426; F04D 29/22; F04D 29/043

(57) ABSTRACT

Disclosed is an electric water pump including: a main body; a motor module including a rotor and a stator to generate a rotational force with power supplied from an outside; a pump module coupled to a first side of the main body, and including an impeller spinning by the rotational force of the motor module, an inlet to introduce a fluid as the impeller spins, and an outlet; a controller housing coupled to a second side of the main body and coupling with a controller for controlling the motor module; and a rotary shaft transmitting the rotational force from the motor module to the impeller, wherein the rotor is formed by performing insert injection-molding after stacking a rotor core and coupling with a magnet, and the rotary shaft is pressed into the rotor so that the rotor and the rotary shaft can be formed as a single body.

### CROSS-REFERENCE TO RELATED THE APPLICATION

This application is based on and claims priority under 35 U.S.C. § 119 to Korean Patent Application No. 10-2020-0168294 filed on Dec. 4, 2020 in the Korean Intellectual Property Office, the disclosure of which is incorporated by reference herein in its entirety.

### BACKGROUND

### Field

The disclosure relates to an electric water pump, and more particularly to an electric water pump used in a vehicle or the like, of which a rotary shaft can have a more convenient structure, and of which a structure is improved to effectively cool relevant elements.

### Description of the Related Art

A vehicle refers to a representative means of transportation in modern times, and includes many parts to be assembled together. In particular, an engine, which produces power in the vehicle, generates a lot of heat.

Generally, a cooling system provided in the engine of the vehicle is to maintain an optimal operating temperature throughout the operating range of the engine, thereby preventing major parts such as a cylinder block, a head, a piston, etc. from damage due to heat generated at the highest temperature during a combustion process of a mixer.

The cooling system of the engine includes a water pump that pumps coolant cooled in a radiator into a water jacket of the engine.

The water pump includes an impeller for circulating a fluid, i.e., water as the coolant, a driving means including the engine or a motor to provide rotary power to the impeller, and a control means for controlling the driving means, various sensors, etc.

The impeller sucks water through an inlet, pressurizes the water, and discharges the water through an outlet to a place where the water is needed.

To generate power for rotating the impeller, a stator and a rotor are provided, and a rotary shaft is coupled to the rotor.

As shown in FIG. 6, a rotary shaft 347 is supported by a bearing because it rotates in a conventional electric water pump 300, and may generate a thrusting force in some cases. As necessary, a thrust plate 329 is provided. The thrust plate 329 rotates and functions to minimize damage of a bearing 323 including a carbon bearing with the minimum rotational friction.

Further, a thrust rubber 328 coupling with the thrust plate 329 supports the thrust plate 329 and functions to absorb a shock. With this function, it is possible to minimize the damage of the bearing 323.

Further, reference numerals not described with reference to FIG. 6 refer to elements having the same function as elements according to the disclosure which will be described later with like reference numerals having the same digit of tens place and the same digit of ones place, and therefore repetitive descriptions thereof will be omitted.

Such a conventional rotary shaft 347 includes a complicated parts or structures.

Further, it is preferable to effectively cool the motor module and the controller which are generating heat.

### DOCUMENTS OF RELATED ART

Korean Patent Publication No. 10-2017-0079382 (published on Jul. 10, 2017)
Korean Patent Publication No. 10-2015-0101555 (published on Sep. 4, 2015).

### SUMMARY

An aspect of the disclosure is to provide an electric water pump, in which a rotary shaft of a motor module and a structure for supporting the rotary shaft are simplified and the number of parts is reduced.

Another aspect of the disclosure is to provide an electric water pump, in which structures or parts of generating heat are effectively cooled.

Still another aspect of the disclosure is to provide an electric water pump, in which a body can has a guiding structure for keeping a certain distance from the center of a rotary shaft during an assembling process.

According to an embodiment, there is provided an electric water pump including: a main body; a motor module coupled to the main body and including a rotor and a stator to generate a rotational force with power supplied from an outside; a pump module coupled to a first side of the main body, and including an impeller spinning by the rotational force of the motor module, an inlet to introduce a fluid as the impeller spins, and an outlet to discharge a pressed fluid; a controller housing coupled to a second side of the main body and coupling with a controller for controlling the motor module; and a rotary shaft transmitting the rotational force from the motor module to the impeller, wherein the rotor is formed by performing insert injection-molding after stacking a rotor core and coupling with a magnet, and the rotary shaft is pressed into the rotor so that the rotor and the rotary shaft can be formed as a single body.

Further, opposite ends of the rotary shaft are supported by bearings including carbon bearings.

Further, the electric water pump may further include: a shaft hole formed in the main body to allow the rotary shaft to pass therethrough; an upper bearing supporting member provided in the main body to support the rotary shaft near the shaft hole and coupling with bearings; a body can coupled to an inner circumferential side of the stator coupled to the main body and separating the rotor from the stator; and a plurality of coolant inflow holes formed outside the upper bearing supporting member and passing through the main body to communicate with an inside of the body can.

Further, the electric water may further include a coolant discharging hole formed passing through the rotary shaft so that a fluid flowing into the coolant inflow hole can pass through bearings for supporting the second side of the rotary shaft via the rotor spinning being accommodated in the body can and be guided toward the impeller by passing through a center of the rotary shaft

Further, the body can may include a can projection which corresponds to a core gap, i.e., a space formed between cores of the stator and protrudes from a plate surface of the body can toward the core gap.

### BRIEF DESCRIPTION OF THE DRAWINGS

The above and/or the aspects will become apparent and more readily appreciated from the following description of exemplary embodiments, taken in conjunction with the accompanying drawings, in which:

FIG. 1 is a perspective view of an electric water pump according to an embodiment of the disclosure;

FIG. 2 is a cross-sectional view of FIG. 1;

FIGS. 3A and 3B are a perspective view in which a pump cover and an impeller are removed to describe a process that coolant flows between a body can and a coolant discharging hole of a rotary shaft, and a partially enlarged view of FIG. 2;

FIG. 4 shows a plan view and a cross-section view for describing a process of integrating a rotor and a rotary shaft;

FIGS. 5A and 5B show a perspective view and a cross-sectional view and a partially enlarged view for describing a process that a body can is coupled to a stator; and

FIG. 6 is a cross-sectional view of a conventional electric water pump.

### DETAILED DESCRIPTION OF EXEMPLARY EMBODIMENTS

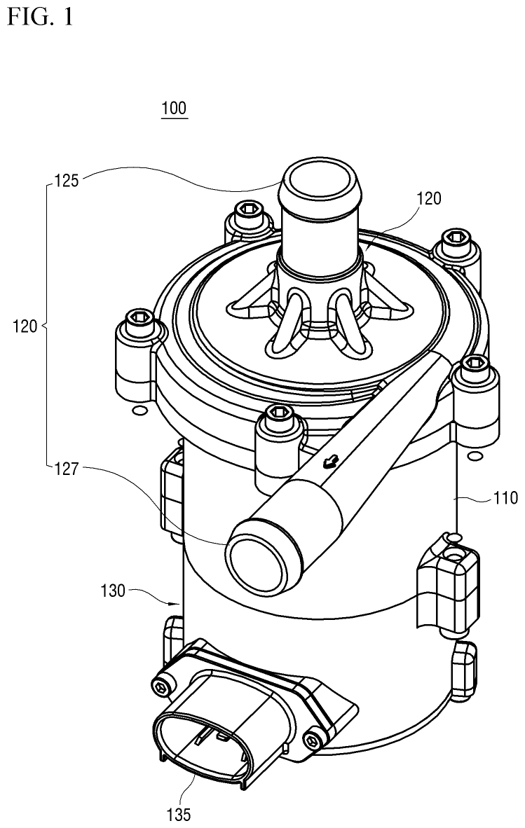

An electric water pump 100 according to the disclosure will be described below in detail with reference to FIGS. 1 to 6.

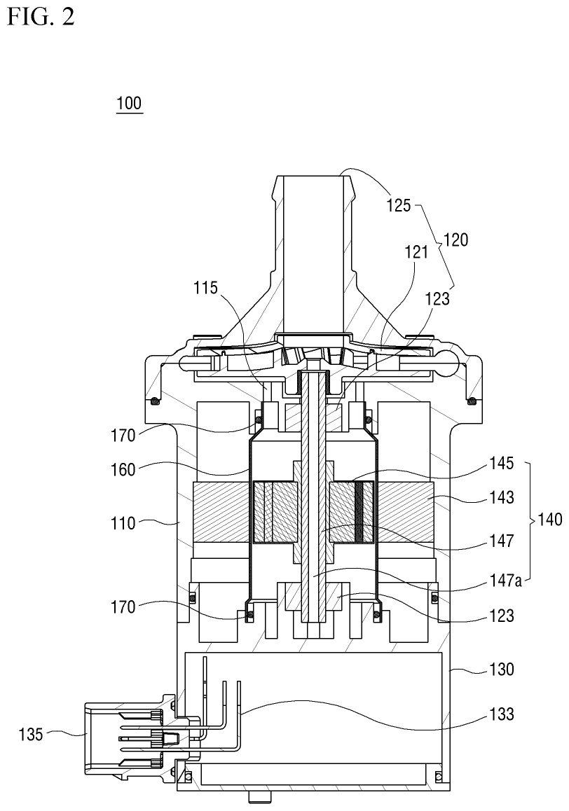

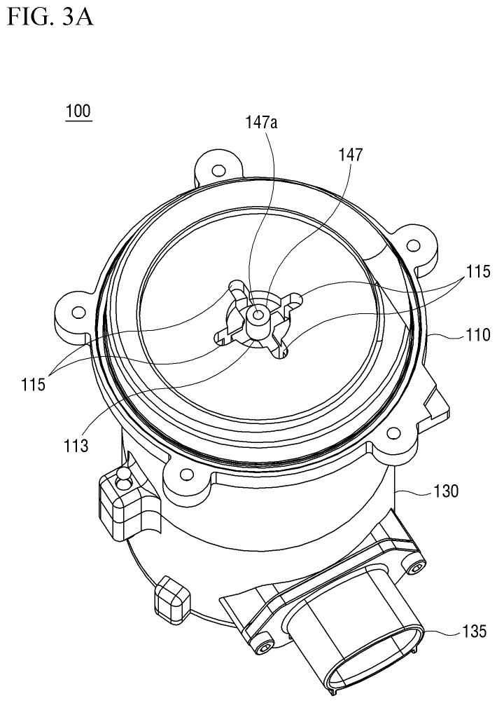

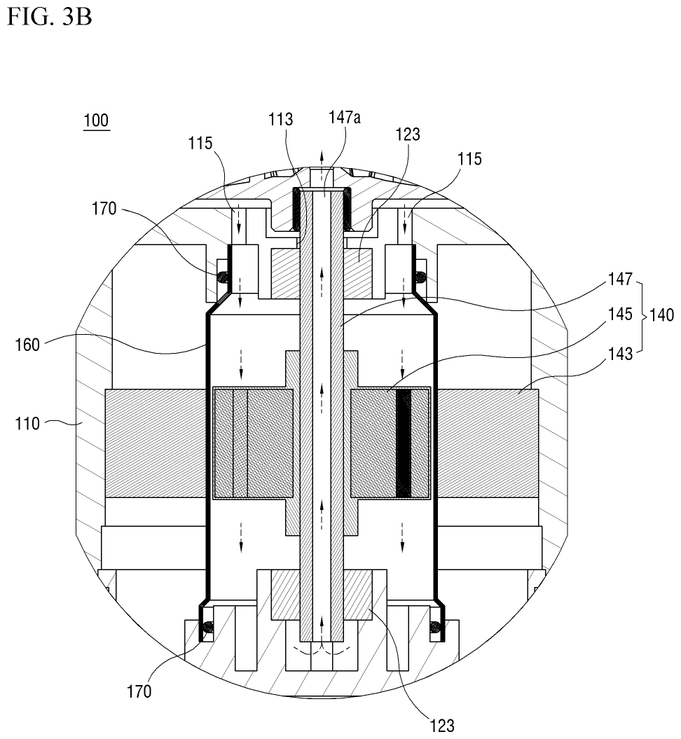

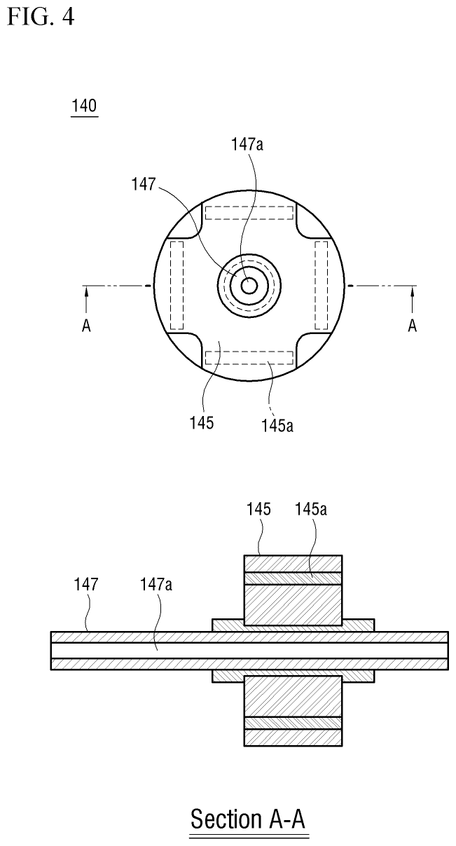

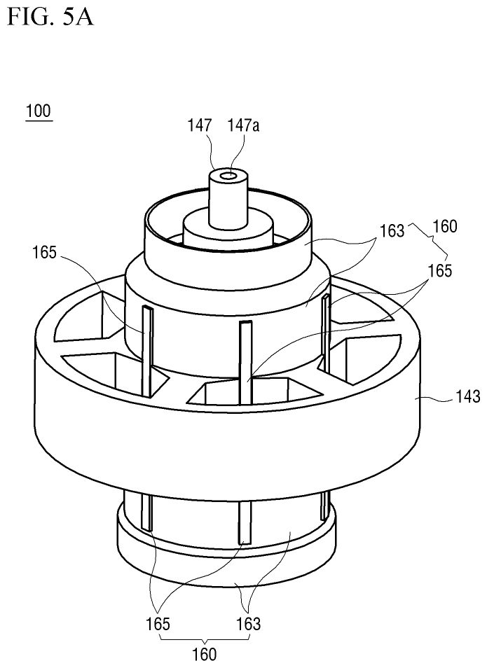

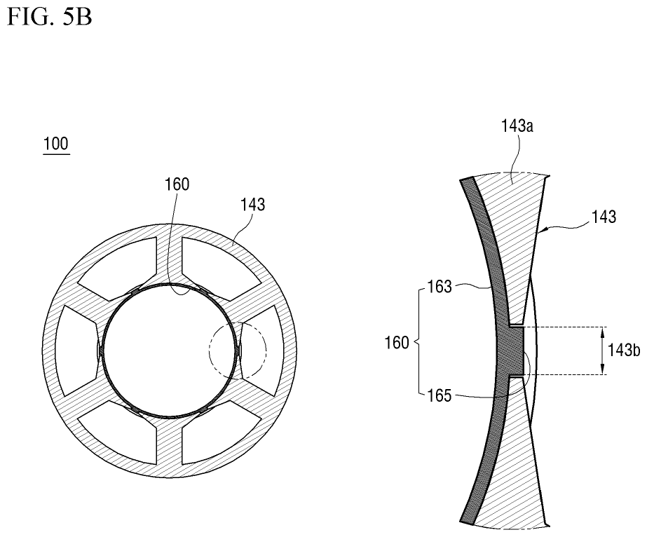

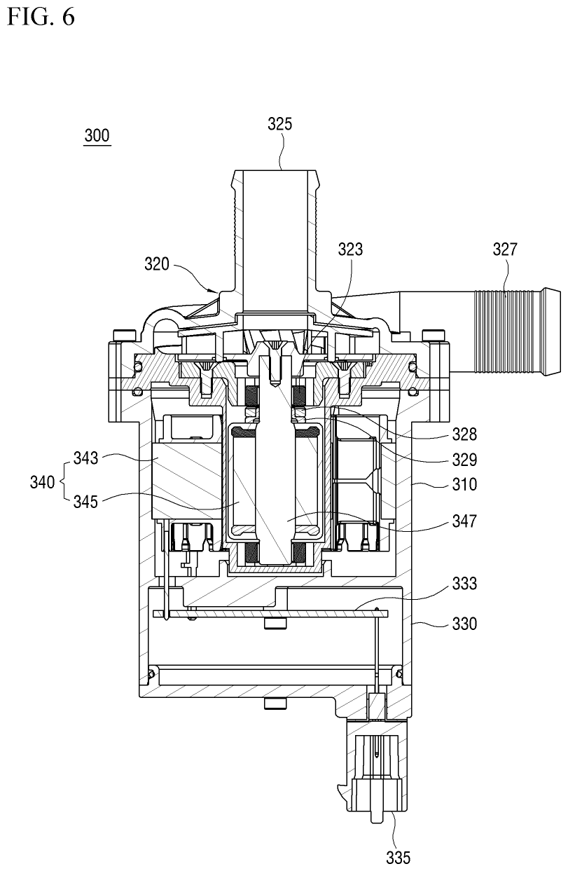

FIG. 1 is a perspective view of an electric water pump according to an embodiment of the disclosure, FIG. 2 is a cross-sectional view of FIG. 1, FIGS. 3A and 3B are a perspective view in which a pump cover and an impeller are removed to describe a process that coolant flows between a body can and a coolant discharging hole of a rotary shaft, and a partially enlarged view of FIG. 2, FIG. 4 shows a plan view and a cross-section view for describing a process of integrating a rotor and a rotary shaft, FIGS. 5A and 5B show a perspective view and a cross-sectional view and a partially enlarged view for describing a process that a body can is coupled to a stator, and FIG. 6 is a cross-sectional view of a conventional electric water pump.

Prior to more detailed description, the disclosure may allow various changes and may have various forms, and therefore aspects (or embodiments) will be described in detail. However, this is not intended to limit the disclosure to specific embodiments, and it should be understood that all changes, equivalents or alternatives can be made without departing from the spirit and scope of the disclosure.

In the accompanying drawings, like reference numerals which are, in particular, equal in both the digit of tens place and the digit of ones place, either the digit of tens place or the digit of ones place, or an alphabet, refer to like elements having the same or similar function. Unless otherwise mentioned, the elements referred to by the reference numerals in the accompanying drawings are regarded as the elements complying with such a rule.

In addition, the elements in the accompanying drawings are exaggerated in size or thickness to be large (or thick) or small (or thin), or simplified for convenience of understanding, but such exaggeration or simplification is not construed as limiting the scope of the disclosure.

The terms used in this specification are only to describe specific aspects (or embodiments), but not intended to restrict the disclosure. Singular forms are intended to include plural forms unless otherwise mentioned contextually. In the present application, it will be understood that terms ‘comprise’, ‘include’, etc. are to designate the presence or addition of one or more other features, numbers, steps, operations, elements, components or combination thereof described in this specification, but do not preclude the presence or addition of one or more other features, numbers, steps, operations, elements, components or combination thereof.

Unless defined otherwise, all terms used herein including technical or scientific terms have the same meanings as generally understood by a person having ordinary knowledge in the art to which the disclosure pertains. The terms defined in general dictionaries are construed as having meanings consistent with the contextual meanings of the art, but not interpreted as ideal meanings or excessively formal meanings unless explicitly defined in the present application.

An electric water pump 100 according to an embodiment of the disclosure, as shown in FIGS. 1 to 5B, may include a main body 110; a motor module 140 coupled to the main body 110 and including a rotor 145 and a stator 143 to generate a rotational force with power supplied from the outside; a pump module 120 coupled to a first side of the main body 110 and including an impeller 121 spinning by the rotational force of the motor module 140, an inlet 125 to introduce a fluid as the impeller 121 spins, and an outlet 127 to discharge a pressed fluid; a controller housing 130 coupled to a second side of the main body 110 and coupling with a controller 133 for controlling the motor module 140; and a rotary shaft 147 transmitting the rotational force from the motor module 140 to the impeller 121, in which the rotor 145 is formed by performing insert injection-molding after stacking a rotor core (not shown) and inserting a magnet 145a, and the rotary shaft 147 is pressed into the rotor 145 so that the rotor 145 and the rotary shaft 147 can be formed as a single body.

The main body 110 forms a middle portion of an outer appearance of the electric water pump 100, the pump module 120 is coupled to an upper side of FIG. 2, and the controller housing 130 is coupled to a lower side, thereby forming an overall outer appearance of the electric water pump 100. Various publicly known methods may be used for the coupling between the main body 110 and the pump module 120 and the coupling between the main body 110 and the controller housing 130.

The upper side of the main body 110 is shaped like a relatively flat plate corresponding to the shape of the impeller 121 so as to form a pressurization chamber (not shown) where a fluid is pressurized together with the pump module 120.

The main body 110 is formed with a shaft hole 113 at the center of an upper plate thereof, so that the rotary shaft 147 can penetrate the upper plate of the main body 110 and couple with the impeller 121.

Under the upper plate, an upper bearing supporting member 117a is formed below the shaft hole 113 and couples with a bearing 123 for rotatably supporting an upper region of the rotary shaft 147.

Further, a plurality of coolant inflow holes 115 are formed passing through the upper plate of the main body 110 outwards from the upper bearing supporting member 117a, thereby communicating with the inside of a body can 160.

According to an embodiment, four coolant inflow holes 115 are formed. However, three coolant inflow holes may alternatively be formed. Further, the plurality of coolant inflow holes 115 may be equidistant from the center of the rotary shaft 147 and formed radially at equal intervals.

The controller 133 may be hermetically accommodated in the controller housing 130, and the controller housing 130 includes a connector 135 to which terminals of cables and the like are connected to receive power from a vehicle main body or an electronic control unit (ECU) and transmit and receive various signals.

The motor module 140 includes the stator 143 and the rotor 145 like a typical electric water pump 100, in which the rotary shaft 147 is coupled to the rotor 145 as described above.

The rotor 145 is, as shown in FIG. 4, formed by stacking the rotor core (not shown), coupling with the magnet 145a, and then performing insert injection molding, and the rotary shaft 147 is pressed into the rotor 145 so that the rotor 145 and the rotary shaft 147 can be formed as a single body. With this structure, the rotor 145 makes the rotary shaft 147 spin more effectively.

Therefore, it is possible to reduce the parts such as the thrust plate 329 and the thrust rubber 328 as mentioned in Description of the Related Art with reference to FIG. 6,

The stator 143 includes a stator core 143a, and a core gap 143b formed as a space between the adjacent stator cores 143a.

The rotary shaft 147 includes a coolant discharging hole 147a formed passing through the center of the rotary shaft 147. Through the coolant discharging hole 147a of the rotary shaft 147, a fluid introduced into the pump module 120 is discharged to the outlet 127 via the impeller 121, in which, as shown in FIGS. 3A and 3B, the fluid flows in an upper space of the body can 160 through the coolant inflow holes 115 formed passing through the upper side of the main body 110, is guided to a lower space of the body can 160 while passing through the rotor 145 or the space between the rotor 145 and the body can 160, and then reaches the top plate of the controller housing 130 via a gap in which the bearing 123 rolls.

As the coolant flows, it is possible to cool the motor module 140, the controller 133, the bearing 123, and the like which generate heat, thereby solving problems of damage due to generated heat generation.

Further, as shown in FIGS. 5A and 5B, the body can 160 includes a can projection 165 which corresponds to the core gap 143b, i.e., the space between the stator cores 143a of the stator 143 and protrudes from a plate surface of a can main body 163 of the body can 160 toward the core gap 143b. With this structure, the can projection 165 engages with the core gap 143b.

During an assembling process of the body can 160, the can projection 165 makes the body can 160 be in position with respect to a central axis or the stator 143. In other words, the can projection 165 guides the body can 160 to be in position with respect to the central axis, i.e., to be parallel to the central axis.

The body can 160 is shaped like a cylinder opened up and down and including a partially bent region along up and down directions, and can O-rings 170 are respectively coupled to the main body 110 and the controller housing 130 at the upper and lower sides so as to prevent a fluid from flowing into the stator 143 in an assembled state.

Thus, according to the disclosure, there is provided an electric water pump, in which a rotary shaft of a motor module and a structure for supporting the rotary shaft are simplified and the number of parts is reduced.

Further, there is provided an electric water pump, in which structures or parts of generating heat are effectively cooled.

In addition, there is provided an electric water pump, in which a body can has a guiding structure for keeping a certain distance from the center of a rotary shaft during an assembling process.

Although a few exemplary embodiments of the disclosure have been shown and described, it will be appreciated by a person having ordinary skill in the art that various changes can be made in these exemplary embodiments without departing from the principles and spirit of the disclosure, the scope of which is defined in the appended claims and their equivalents.

### REFERENCE NUMERALS

| 100, 300: water pump | 110: main body |
|---|---|
| 113: shaft hole | 115: coolant inflow hole |
| 117a: upper bearing supporting member | |
| 117b: lower bearing supporting member | |
| 120: pump module | 121: impeller |
| 123: bearing | 125: inlet |
| 127: outlet | 130: controller housing |
| 133: controller | 135: connector |
| 140: motor module | 143: stator |
| 143a: stator core | 143b: core gap |
| 145: rotor | 145a: magnet |
| 147: rotary shaft | |
| 147a: coolant discharging hole | |
| 160: body can | 163: can main body |
| 165: can projection | 170: can O-ring |

What is claimed is:

1. An electric water pump comprising:
a main body;
a motor module coupled to the main body and comprising a rotor and a stator to generate a rotational force with power supplied from an outside;
a pump module coupled to a first side of the main body, and comprising an impeller spinning by the rotational force of the motor module, an inlet to introduce a fluid as the impeller spins, and an outlet to discharge a pressed fluid;
a controller housing coupled to a second side of the main body and coupling with a controller for controlling the motor module; and
a rotary shaft transmitting the rotational force from the motor module to the impeller,
wherein the rotor is formed by performing insert injection-molding after stacking a rotor core and coupling with a magnet, and the rotary shaft is pressed into the rotor so that the rotor and the rotary shaft can be formed as a single body.

2. The electric water pump according to claim 1, wherein opposite ends of the rotary shaft are supported by bearings comprising carbon bearings.

3. The electric water pump according to claim 1, further comprising:
a shaft hole formed in the main body to allow the rotary shaft to pass therethrough;
an upper bearing supporting member provided in the main body to support the rotary shaft near the shaft hole and coupling with bearings;
a body can coupled to an inner circumferential side of the stator coupled to the main body and separating the rotor from the stator; and
a plurality of coolant inflow holes formed outside the upper bearing supporting member and passing through the main body to communicate with an inside of the body can.

4. The electric water pump according to claim 3, further comprising a coolant discharging hole formed passing through the rotary shaft so that a fluid flowing into the coolant inflow hole can pass through bearings for supporting the second side of the rotary shaft via the rotor spinning being accommodated in the body can and be guided toward the impeller by passing through a center of the rotary shaft.

5. The electric water pump according to claim 3, wherein the body can comprises a can projection which corresponds to a core gap, i.e., a space formed between cores of the stator and protrudes from a plate surface of the body can toward the core gap.
